(19) United States
(12) Patent Application Publication
(10) Pub. No.: US 2026/0091968 A1
(43) Pub. Date: Apr. 2, 2026

(54) VEHICLE BOTTLE OPENER ASSEMBLIES WITH MAGNETIC BOTTLE CAP OPENING AND CAPTURE AND STORAGE FEATURES

(71) Applicant: FORD GLOBAL TECHNOLOGIES, LLC, Dearborn, MI (US)

(72) Inventors: Norberto Mondragon Hernandez, Mexico CIty (MX); Brenda Guadalupe Tenorio Hernandez, Mexico City (MX); Juan Adrian Avelar Martinez, Mexico City (MX); Sabrina Zamora Maynes, Mexico City (MX); Keevyn Fernando Rivera Fragoso, Mexico City (MX)

(21) Appl. No.: 18/898,874

(22) Filed: Sep. 27, 2024

(51) Int. Cl. B67B 7/16

(52) U.S. Cl. CPC B67B 7/16

(57) ABSTRACT

Vehicle bottle opener assemblies can increase the functionality of a motor vehicle. An exemplary bottle opener assembly may be mounted to a portion of a vehicle body and includes integrated bottle opener and magnetic cap capture and storage portions. The magnetic cap capture and storage portion may be configured to collect bottle caps after they are dislodged by the bottle opener portion. The bottle opener assembly may be conveniently packaged on the vehicle for use during outdoor social gatherings when a vehicle closure member is moved to an open position during stationary, non-moving conditions of the vehicle.

### TECHNICAL FIELD

This disclosure relates generally to motor vehicles, and more particularly to vehicle bottle opener assemblies that are equipped with integrated bottle opener and cap capture and storage features.

### BACKGROUND

Vehicles can be utilized as social gathering spots during outdoor activities, such as camping and tailgating activities. Vehicle users typically must remember to carry various tools and convenience items on the vehicle, such as bottle openers, for example, for facilitating a more enjoyable experience during the outdoor social activities.

### SUMMARY

A motor vehicle according to an exemplary aspect of the present disclosure includes, among other things, a vehicle body, and a bottle opener assembly mounted to the vehicle body and including a bottle opener portion and a magnetic cap capture and storage portion.

In a further non-limiting embodiment of the foregoing motor vehicle, the bottle opener assembly is mounted to a door opening panel of the vehicle body.

In a further non-limiting embodiment of either of the foregoing motor vehicles, the door opening panel interfaces with a closure member of the motor vehicle when the closure member is in a closed position relative to the vehicle body.

In a further non-limiting embodiment of any of the foregoing motor vehicles, the closure member is a liftgate.

In a further non-limiting embodiment of any of the foregoing motor vehicles, the magnetic cap capture and storage portion includes a magnet located inside a wall section of the magnetic cap capture and storage portion.

In a further non-limiting embodiment of any of the foregoing motor vehicles, the wall section cooperates with additional wall sections to provide a trough of the magnetic cap capture and storage portion.

In a further non-limiting embodiment of any of the foregoing motor vehicles, the trough is configured to capture a bottle cap that has been dislodged from a bottle by the bottle opener portion.

In a further non-limiting embodiment of any of the foregoing motor vehicles, a body of the bottle opener portion is integrally formed with a wall section of the magnetic cap capture and storage portion.

In a further non-limiting embodiment of any of the foregoing motor vehicles, a mounting flange is integrally formed with the body or the wall section.

In a further non-limiting embodiment of any of the foregoing motor vehicles, the bottle opener portion includes a body and a bottle opener held within the body. The bottle opener includes a tab and a lower edge that cooperate to apply an opening force for removing a bottle cap from a bottle when the bottle is oriented and moved relative to the bottle opener by a user.

A motor vehicle according to another exemplary aspect of the present disclosure includes, among other things, a bottle opener assembly including a bottle opener portion, a magnetic cap capture and storage portion, and a mounting portion.

In a further non-limiting embodiment of the foregoing motor vehicle, the bottle opener assembly is mounted to a door opening panel of a vehicle body.

In a further non-limiting embodiment of either of the foregoing motor vehicles, the door opening panel interfaces with a closure member of the motor vehicle when the closure member is in a closed position relative to the vehicle body.

In a further non-limiting embodiment of any of the foregoing motor vehicles, the closure member is a liftgate.

In a further non-limiting embodiment of any of the foregoing motor vehicles, the magnetic cap capture and storage portion includes a magnet located inside a wall section of the magnetic cap capture and storage portion.

In a further non-limiting embodiment of any of the foregoing motor vehicles, the wall section cooperates with additional wall sections to provide a trough of the magnetic cap capture and storage portion.

In a further non-limiting embodiment of any of the foregoing motor vehicles, the trough is configured to magnetically capture a bottle cap that has been dislodged from a bottle by the bottle opener portion.

In a further non-limiting embodiment of any of the foregoing motor vehicles, a body of the bottle opener portion is integrally formed with a wall section of the magnetic cap capture and storage portion.

In a further non-limiting embodiment of any of the foregoing motor vehicles, a first mounting flange of the mounting portion is integrally formed with the body or the wall section.

In a further non-limiting embodiment of any of the foregoing motor vehicles, a second mounting flange of the mounting portion is integrally formed with the other of the body or the wall section.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a rear view of a motor vehicle equipped with a closure member. The closure member is in a closed position in FIG. 1.

FIG. 2 illustrates an open position of the closure member of FIG. 1.

FIG. 3 illustrates a bottle opener assembly mounted to a vehicle body of the vehicle of FIGS. 1 and 2.

FIG. 4 is a cross-sectional view through section 4-4 of FIG. 3.

FIG. 5 illustrates a bottle opener of the bottle opener assembly of FIG. 3.

FIG. 6 illustrates another exemplary bottle opener assembly for a vehicle.

FIG. 7 illustrates an exemplary use of a vehicle bottle opener assembly for removing and temporarily storing a bottle cap from a bottle.

### DETAILED DESCRIPTION

This disclosure details vehicle bottle opener assemblies for increasing the functionality of a motor vehicle. An exemplary bottle opener assembly may be mounted to a portion of a vehicle body and includes integrated bottle opener and magnetic cap capture and storage portions. The magnetic cap capture and storage portion may be configured to collect bottle caps after they are dislodged by the bottle opener portion. The bottle opener assembly may be conveniently packaged on the vehicle for use during outdoor social gatherings when a vehicle closure member is moved to an open position during stationary, non-moving conditions of the vehicle. These and other features of this disclosure are described in greater detail below.

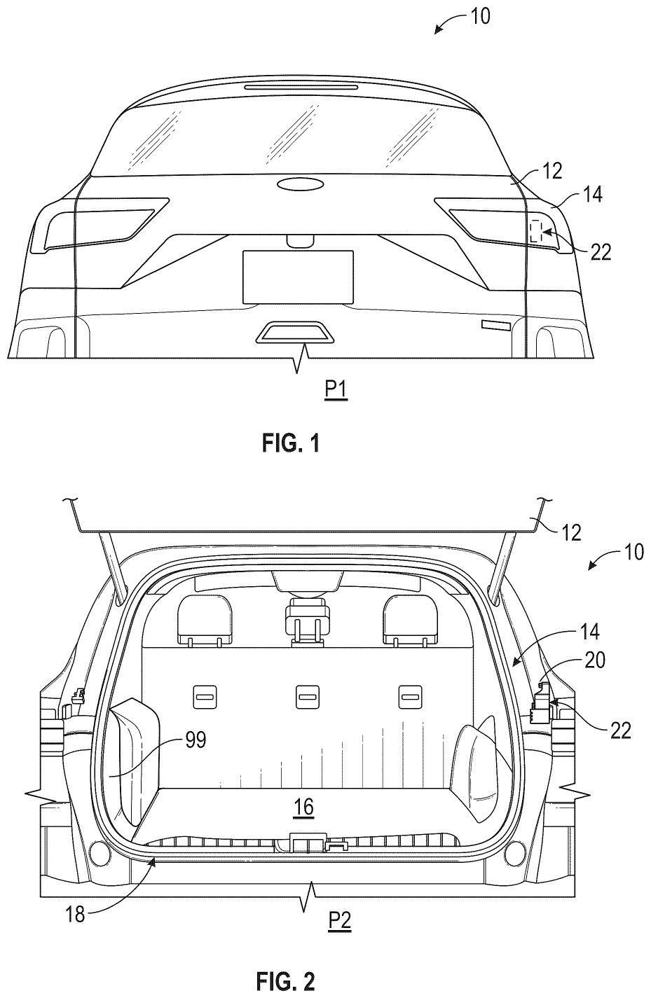

FIGS. 1 and 2 schematically illustrate select portions of a motor vehicle 10 (hereinafter referred to simply as “vehicle”). The vehicle 10 may be a sport utility vehicle, a car, a truck, or any other type of vehicle. The vehicle 10 could also be a conventional motor vehicle, a traction battery powered hybrid or electric vehicle, or an autonomous vehicle (i.e., a driverless vehicle).

Although a specific component relationship is illustrated in the figures of this disclosure, the illustrations are not intended to limit this disclosure. In other words, the placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

The vehicle 10 may include one or more closure members 12 that are mounted to a vehicle body 14 and configured to move (e.g., pivot) between closed and open positions for accessing a vehicle interior 16 (e.g., a cargo space, a passenger cabin, etc.). The closure member 12 of the vehicle 10 is shown in a closed position P1 in FIG. 1 and an open position P2 in FIG. 2. When moved to the open position P2, the closure member 12 permits users to access the vehicle interior 16. When closed, the closure member 12 provides a barrier between the vehicle interior 16 and an exterior environment outside of the vehicle 10.

In the illustrated embodiment, the closure member 12 is mounted at a rear 18 of the vehicle 10 and is configured as a liftgate. However, the teachings of this disclosure are not limited to vehicles with liftgates and could apply to various other types of closure members, including but not limited to tailgates, decklids, etc.

The closure member 12 may be movably mounted relative to a door opening panel 20 (see FIG. 2) of the vehicle body 14. Laterally outboard side sections of the closure member 12 may interface with the door opening panel 20 when the closure member 12 is in the closed position P1. Portions of the door opening panel 20 may be exposed when the closure member 12 is moved to the open position P2 of FIG. 2.

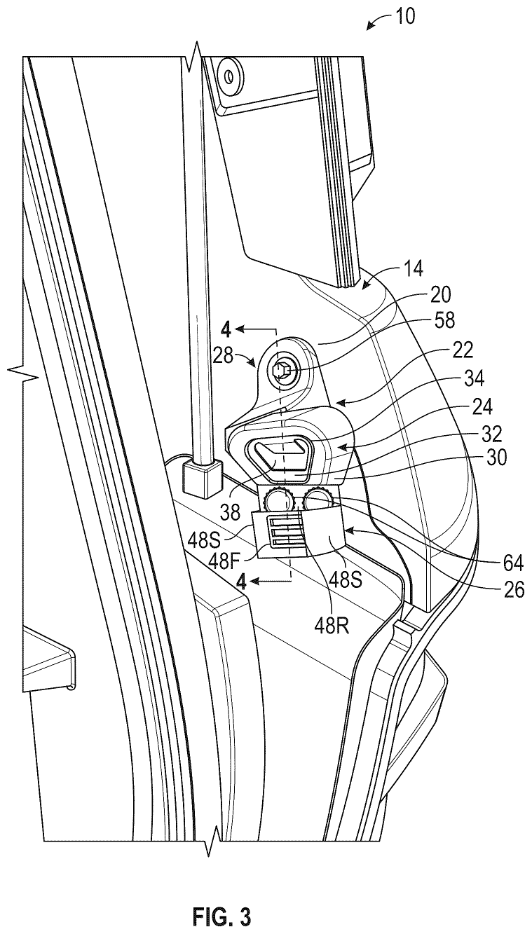

Referring now to FIGS. 3, 4, 5, and 6, and with continued reference to FIGS. 1-2, a bottle opener assembly 22 may be mounted to the vehicle body 14 in order to facilitate a more enjoyable user experience when using the vehicle 10 as a social gathering spot during outdoor activities (e.g., camping, tailgating, etc.) while the vehicle 10 is stationary. In an embodiment, the bottle opener assembly 22 is mounted directly to the door opening panel 20 of the vehicle body 14. However, other mounting locations are contemplated within the scope of this disclosure. For example, in other implementations, the bottle opener assembly 22 could be mounted within the vehicle interior 16, such as to an interior wall 99 (see FIG. 2) associated with a rear cargo space, for example. Furthermore, in other implementations, multiple bottle opener assemblies could be mounted at different locations of the vehicle body 14.

The bottle opener assembly 22 may include a bottle opener portion 24, a magnetic cap capture and storage portion 26, and a mounting portion 28. Together, the bottle opener portion 24, the magnetic cap capture and storage portion 26, and the mounting portion 28 establish an integrated, single-piece structure of the bottle opener assembly 22.

The bottle opener portion 24 may include a body 30 and a bottle opener 32. In an embodiment, the body 30 is made of a relatively hard plastic material (e.g. thermoplastic olefin (TPO), etc.) In another embodiment, the body 30 is made of a metallic material.

The bottle opener 32 may be imbedded or otherwise held in place within an opening 34 (e.g., groove) formed in the body 30. The bottle opener 32 may be made of a metallic material.

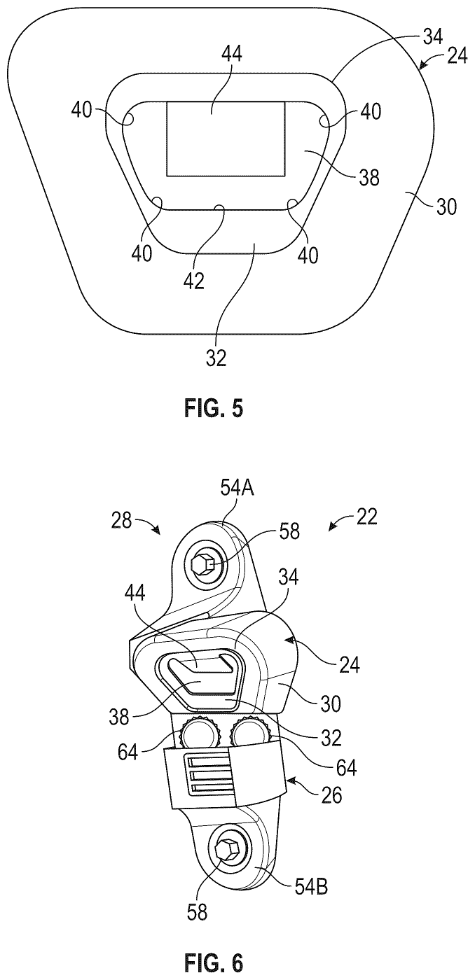

An opening 38 may be formed through the bottle opener 32. The opening 38 may be, in an exemplary embodiment, trapezoidal in shape and may include four curved corners 40 (see FIG. 5). A lower edge 42 of the opening 38 may be configured for applying an opening force for removing a bottle cap from a bottle, as further discussed below.

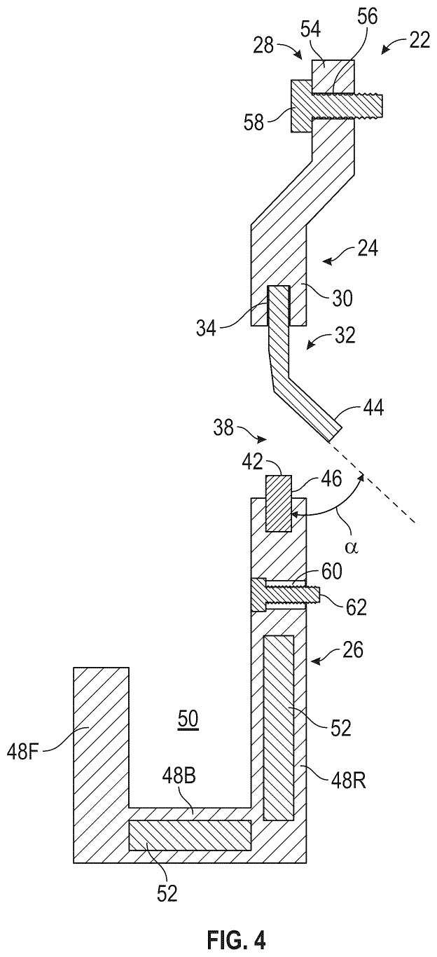

A tab 44 of the bottle opener 32 may extend inwardly into the opening 38. The tab 44 may be configured to control the amount of swing necessary to remove a bottle cap from a bottle via the lower edge 42. The tab 44 may extend at an angle α (see FIG. 4) relative to an interior facing surface 46 of the bottle opener 32. The angle α can be optimized per design requirements for properly aligning a bottle relative to the bottle opener 32 at an angle that maintains clearances between the bottle and nearby vehicle components, such as the door opening panel 20, for example.

The magnetic cap capture and storage portion 26 may include a plurality of wall sections 48. For example, the magnetic cap capture and storage portion 26 may include a front wall section 48F, a rear wall section 48R, side wall sections 48S, and a bottom wall section 48B. The front wall section 48F, the rear wall section 48R, the side wall sections 48S, and the bottom wall section 48B may be arranged together to establish a trough 50 for catching and storing bottle caps that have been dislodged by the bottle opener 32 of the bottle opener portion 24.

The magnetic cap capture and storage portion 26 may be integrally formed with the body 30 of the bottle opener portion 24. For example, the rear wall section 48R may be integrally formed with the body 30. The magnetic cap capture and storage portion 26 may therefore extend below the bottle opener portion 24 for capturing and storing bottle caps after they have been dislodged by the bottle opener 32.

A magnet 52 may be embedded or otherwise held inside one or more of the wall sections 48 of the magnetic cap capture and storage portion 26. In an embodiment, both the rear wall section 48R and the bottom wall section 48B include one or more magnets 52 (see FIG. 4). However, other configurations are contemplated within the scope of this disclosure. Each magnet 52 may be configured to magnetically attract and capture bottle caps that have been dislodged by the bottle opener 32, thereby conveniently catching and holding the bottle caps as they are removed and preventing them from littering the vehicle interior 16 and the exterior environment surrounding the vehicle 10.

The mounting portion 28 of the bottle opening assembly 22 may include one or more mounting flanges 54. In an embodiment, the mounting portion 28 may include a single mounting flange 54 that extends transversely away from the body 30 of the bottle opener portion 24 (see FIGS. 3-4). The mounting flange 54 may be integrally formed with the body 30.

In another embodiment, the mounting portion 28 may include a first mounting flange 54A that extends from the bottle opener portion 24 and a second mounting flange 54B that extends from the magnetic cap capture and storage portion 26 (see FIG. 6). The first mounting flange 54A may be integrally formed with the body 30 of the bottle opener portion 24, and the second mounting flange 54B may be integrally formed with the magnetic cap capture and storage portion 26.

An opening 56 may be formed through each mounting flange 54. Each opening 56 may be sized to receive a mechanical fastener 58 for mounting the bottle opener assembly 22 to the vehicle body 14.

In some implementations, an additional opening 60 (see FIG. 4) may be formed through the rear wall section 48R of the magnetic cap capture and storage portion 26. The opening 60 may be sized to receive an additional mechanical fastener 62 for mounting the bottle opener assembly 22 to the vehicle body 14.

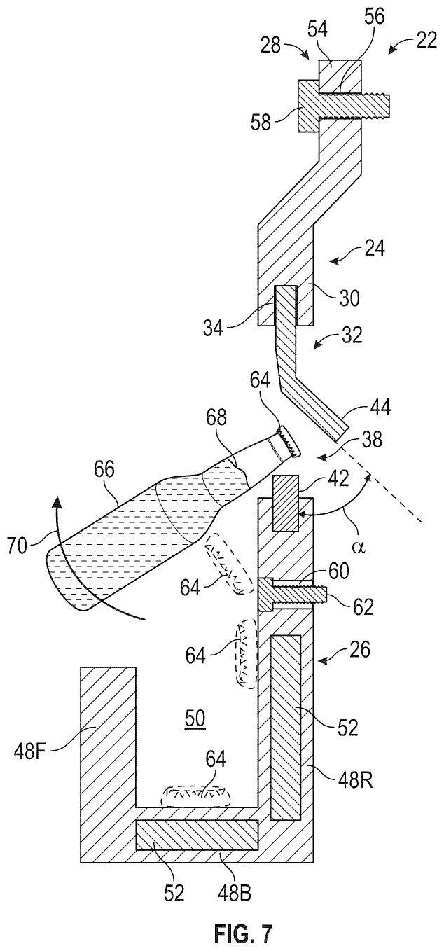

FIG. 7, with continued reference to FIGS. 1-6, schematically illustrates an exemplary use of the bottle opener assembly 22 for opening a bottle 66 that contains a beverage 68. The bottle opener assembly 22 is accessible by users when the vehicle 10 is stationary and when the closure member 12 is opened and is therefore conveniently packaged near the vehicle interior 16. The bottle opener assembly 22 may be used during outdoor social gatherings and eliminates the need for the user to store a separate bottle opener on the vehicle 10.

Prior to opening, the beverage 68 is contained within the bottle 66 by a bottle cap 64. The bottle opener portion 24 of the bottle opener assembly 22 may be used to remove the bottle cap 64 without spilling the beverage 68, and the magnetic cap capture and storage portion 26 of the bottle opener assembly 22 may be used to temporarily store the bottle cap 64 once removed from the bottle 66 by the bottle opener 32.

The bottle cap 64 may be removed from the bottle 66 via the bottle opener assembly 22 in the following exemplary manner. A user may first position the bottle 66 so the bottle cap 64 is at least partially received within the opening 38 of the bottle opener 32. The positioning of the tab 44 relative to the opening 38 forces the user to position the bottle 66 at a specific angle relative to the bottle opener 32. In particular, the tab 44 positions the bottle 66 such that an upward swing path (shown schematically via arrow 70) is required to remove the bottle cap 64 from the bottle 66. The user is thus not permitted to position the bottle 66 at a downward angle relative to the bottle opener 32, thereby substantially preventing spills.

As the user moves the bottle 66 along the upward swing path 70, the bottle cap 64 is forced into engagement with the lower edge 42 of the opening 38, thereby applying an opening force for removing the bottle cap 64 from the bottle 66. The tab 44 may support and stabilize the bottle 66 as it is moved along the upward swing path 70.

The dislodged bottle cap 64 (shown in phantom in FIG. 7) may be captured within the trough 50 of the magnetic cap capture and storage portion 26 for temporary storage, thereby maintaining a clean camp/tailgating site. In some instances, the dislodged bottle cap 64 may be magnetically retained against one of the wall sections 48 of the trough 50 by the magnets 52. The magnets 52 can therefore help ensure that bottle caps 64 do not inadvertently fall out of the trough 50 before, during, and/or after the bottle opening process.

The bottle opener assemblies of this disclosure include integrated bottle opening and bottle cap storage features that are packaged together with one another to provide a convenient way to remove and securely capture and organize bottle caps when utilizing a motor vehicle during outdoor social gatherings. The bottle opener assemblies thus promote a clean and clutter-free environment and reduce littering both inside and external to the vehicle.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A motor vehicle, comprising:
a vehicle body; and
a bottle opener assembly mounted to the vehicle body and including a bottle opener portion and a magnetic cap capture and storage portion.

2. The motor vehicle as recited in claim 1, wherein the bottle opener assembly is mounted to a door opening panel of the vehicle body.

3. The motor vehicle as recited in claim 2, wherein the door opening panel interfaces with a closure member of the motor vehicle when the closure member is in a closed position relative to the vehicle body.

4. The motor vehicle as recited in claim 3, wherein the closure member is a liftgate.

5. The motor vehicle as recited in claim 1, wherein the magnetic cap capture and storage portion includes a magnet located inside a wall section of the magnetic cap capture and storage portion.

6. The motor vehicle as recited in claim 5, wherein the wall section cooperates with additional wall sections to provide a trough of the magnetic cap capture and storage portion.

7. The motor vehicle as recited in claim 6, wherein the trough is configured to capture a bottle cap that has been dislodged from a bottle by the bottle opener portion.

8. The motor vehicle as recited in claim 1, wherein a body of the bottle opener portion is integrally formed with a wall section of the magnetic cap capture and storage portion.

9. The motor vehicle as recited in claim 8, comprising a mounting flange integrally formed with the body or the wall section.

10. The motor vehicle as recited in claim 1, wherein the bottle opener portion includes a body and a bottle opener held within the body, the bottle opener including a tab and a lower edge that cooperate to apply an opening force for removing a bottle cap from a bottle when the bottle is oriented and moved relative to the bottle opener by a user.

11. A motor vehicle, comprising:
a bottle opener assembly including:
a bottle opener portion;
a magnetic cap capture and storage portion; and
a mounting portion.

12. The motor vehicle as recited in claim 11, wherein the bottle opener assembly is mounted to a door opening panel of a vehicle body.

13. The motor vehicle as recited in claim 12, wherein the door opening panel interfaces with a closure member of the motor vehicle when the closure member is in a closed position relative to the vehicle body.

14. The motor vehicle as recited in claim 13, wherein the closure member is a liftgate.

15. The motor vehicle as recited in claim 11, wherein the magnetic cap capture and storage portion includes a magnet located inside a wall section of the magnetic cap capture and storage portion.

16. The motor vehicle as recited in claim 15, wherein the wall section cooperates with additional wall sections to provide a trough of the magnetic cap capture and storage portion.

17. The motor vehicle as recited in claim 16, wherein the trough is configured to magnetically capture a bottle cap that has been dislodged from a bottle by the bottle opener portion.

18. The motor vehicle as recited in claim 11, wherein a body of the bottle opener portion is integrally formed with a wall section of the magnetic cap capture and storage portion.

19. The motor vehicle as recited in claim 18, wherein a first mounting flange of the mounting portion is integrally formed with the body or the wall section.

20. The motor vehicle as recited in claim 19, wherein a second mounting flange of the mounting portion is integrally formed with the other of the body or the wall section.
